(19) United States
(12) Patent Application Publication
(10) Pub. No.: US 2010/0227548 A1
(43) Pub. Date: Sep. 9, 2010

(54) REPEATER INTERFACE UNIT AND SIGNAL CONVERTING METHOD THEREOF

(75) Inventor: Joo Hong Cheon, Seongnam-Si (KR)

Correspondence Address: BLANK ROME LLP, WATERGATE, 600 NEW HAMPSHIRE AVENUE, N.W., WASHINGTON, DC, 20037, US

(73) Assignee: POSDATA CO., LTD

(21) Appl. No.: 12/294,514

(22) PCT Filed: Apr. 18, 2007
(86) PCT No.: PCT/KR07/01880

§ 371 Date: Sep. 25, 2008

(30) Foreign Application Priority Data
Apr. 18, 2006 (KR) 10-2006-0035096

(51) Int. Cl. H04B 7/14

(52) U.S. Cl. 455/20

(57) ABSTRACT

A repeater interface unit for a TX path includes a first reference signal generator for generating a reference signal for an intermediate band conversion; a first mixer for mixing an input signal with the reference signal to generate an intermediate band signal; a second reference signal generator for generating a reference signal for output conversion with one of a plurality of frequencies; a second PLL circuit for stabilizing the reference signal for output conversion; a second mixer for mixing the intermediate band signal generated by the second mixer with the reference signal for output conversion to generate an output signal; and a second filtering means for filtering the output signal of the second mixer.

### TECHNICAL FIELD

The present invention relates to a repeater interface unit (RIFU) for data transmission and reception between a wireless communication base station and an optical repeater, and a method for signal conversion in the repeater interface unit. More particularly, the invention relates to a repeater interface unit used in a frequency conversion path for data transmission and reception between a base station and an optical repeater in a mobile Internet system.

### BACKGROUND ART

To smoothly provide wireless communication services such as code division multiple access (CDMA) cellular, personal communications system (PCS), and Wibro (Wireless broadband internet) services in mountainous terrain, farmland, seacoast, sparsely populated rural areas, radio wave shadow areas such as back roads, and weak radio wave regions, a frequency conversion repeater is used. It is common for a repeater to be used to build a smooth communication environment and extend coverage in a mobile communication system. The repeater has the advantages of reduced apparatus and operation costs and easy installation which enables early return on investment. Accordingly, the repeater is expected to be widely used to extend service coverage into radio wave shadow areas, non-serviced regions, etc.

A conventional radio frequency (RF) repeater amplifies a weak signal from a base station and retransmits it. A relay frequency between the base station and the repeater is the same as a service frequency of the repeater, which causes oscillation in the repeater. The RF repeater has disadvantages of poor isolation and insufficient transmission efficiency. In recent years, an optical repeater has become widely used.

Meanwhile, a wireless communication system may operate a plurality of frequency assignments (FAs) to address increased communication traffic in one base station. In a specific case, a base station may uses different FAs in each sector of the base station. Here, an optical repeater is used for repeating signals having different frequencies. A repeater interface unit converting into signals suitable for repeaters in each frequency should be fabricated in accordance with each frequency. It is necessary for one repeater interface unit to select one frequency from the different frequencies, and perform frequency conversion. This allows for mass production of repeaters equipment and easy FA conversion in a base station.

Conventionally, an optical repeater generates an output signal having a frequency band selected from a plurality of frequency band and generates an input signal having one frequency band. Specifically, the optical repeater generates a reference wave having one frequency selected from a plurality of frequency band, and generates an output signal of suitable band by converting the input signal using the reference wave. However, this method has the following problems. First, in a repeater interface unit for a transmission (TX) path that outputs a selective output signal, a filter for filtering a mixed signal needs to have a pass band covering all possible bandwidths of an output signal. In this case, noise is not sufficiently suppressed. Second, when the frequency of a reference wave with a variable bandwidth is lower than 100 MHz, a variable band phase locked loop (PLL) circuit for stabilizing the reference wave is difficult to implement. Third, a band pass filter cannot sufficiently eliminate noise from a mixed signal when the frequency of the mixed signal is as low as 15 MHz.

### DISCLOSURE OF INVENTION

### Technical Problem

The present invention is directed to a repeater interface unit and a method for signal conversion in the repeater interface unit, which are capable of efficiently converting a frequency without conversion loss or added conversion noise.

The present invention is also directed to a repeater interface unit and a method for signal conversion in the repeater interface unit, which are capable of efficiently performing frequency conversion on a signal transmission path between an optical repeater module and an analog/digital (A/D) or digital/analog (D/A) converter.

The present invention is also directed to a repeater interface unit capable of serving a frequency band between several hundreds of MHz and several tens of MHz for a plurality of frequency assignments (FAs).

The present invention is also directed to a repeater interface unit having high scalability, which allows FA conversion to be easily made in a base station by using a plurality of FAs, and which can satisfy requirements of a multiple FA or sector environment.

The present invention is also directed to a repeater interface unit capable of increasing production efficiency of repeater/repeater equipment.

### Technical Solution

One aspect of the present invention provides a repeater interface unit comprising a first reference signal generator for generating a first reference signal; a first mixer for mixing the input signal with the first reference signal and for generating an intermediate band signal; a second reference signal generator for generating a second reference signal; a second mixer for mixing the intermediate band signal generated by the first mixer with the second reference signal and for generating an output signal; and a filtering means for filtering the output signal of the second mixer to select a minus mixing signal.

Another aspect of the present invention provides a method for signal conversion in a repeater interface unit, comprising the steps of: mixing the input signal with a first reference signal; filtering the intermediate band signal to select a plus mixing signal; mixing the plus mixing signal with a second reference signal; and filtering the output signal to select a minus mixing signal.

A repeater interface unit for a TX path in a conventional superheterodyne system performs two plus mixing on a low-frequency signal using a mixer to generate a higher-frequency signal, while the repeater interface unit for a TX path of the present invention may perform one plus mixing and one minus mixing on a low-frequency signal using a mixer to generate a higher-frequency signal.

Furthermore, the repeater interface unit for an RX path in the conventional superheterodyne system performs two minus mixing on a high-frequency signal using a mixer to generate a lower-frequency signal, while the repeater interface unit for an RX path of the present invention may perform one plus mixing and one minus mixing on a high-frequency signal to generate a lower-frequency signal.

The repeater interface unit according to the present invention may be used to convert a frequency of data transferred between base station equipment of a provider of mobile Internet service (e.g., Wibro service) in which reaction of a base station to variation of communication traffic in its service area is important, and an optical repeater in a shadow area or the like.

Base station equipment such as a mobile Internet system may comprise a plurality of channel cards that respectively serve a plurality of sectors into which a circular coverage area is divided. The base station equipment may further comprise a plurality of channel cards having different frequency assignments (FAs) in the same sector to handle any sector where communication traffic increases

When the equipment comprises a plurality of channel cards or will comprise the channel cards, a repeater interface unit for an optical repeater needs to convert a number of operating frequencies into optical transmission frequencies or the optical transmission frequencies into the operating frequencies. In general, by compromise between scalability and hardware conservation, a repeater interface unit may be used for conversion between three adjacent operating frequencies and an optical transmission frequency.

### Advantageous Effects

As described above, the repeater interface unit according to the present invention can efficiently convert a frequency without conversion loss or added conversion noise.

The repeater interface unit can efficiently perform data frequency conversion between the optical repeater module and the A/D or D/A converter.

The repeater interface unit can select one of a plurality of FAs and serve several hundreds of MHz to several tens of MHz.

### BRIEF DESCRIPTION OF THE DRAWINGS

FIG. 1 is a circuit diagram illustrating a comparative example of a repeater interface unit for a TX path that comprises one mixer and outputs a 3FA output signal;

FIG. 2 is a circuit diagram illustrating a comparative example of a repeater interface unit for an RX path that comprises one mixer and receives a 3FA input signal;

FIGS. 3a and 3b are a circuit diagram and a phase diagram illustrating a repeater interface unit for a TX path that comprises two mixers and outputs a 3FA output signal according to an exemplary embodiment of the present invention; and

FIGS. 4a and 4b are a circuit diagram and a phase diagram illustrating a repeater interface unit for an RX path that comprises two mixers and receives a 3FA input signal according to an exemplary embodiment of the present invention.

### DESCRIPTION OF MAJOR COMPONENTS IN THE ABOVE FIGURES

312, 412: First mixer
314, 414: First reference wave generator
316, 416: First PLL circuit
318, 418: First band pass filter
322, 422: Second mixer
324, 424: Second reference wave generator
326, 426: Second PLL circuit
328, 428: Second band pass filter

### MODE FOR THE INVENTION

### Comparative Example 1

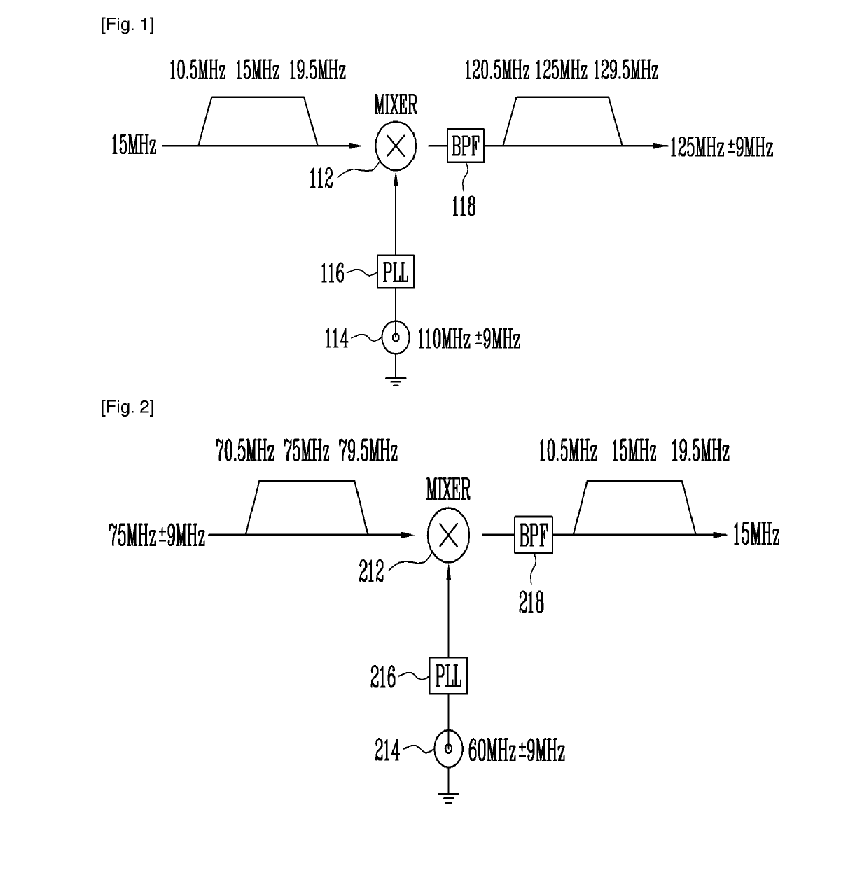

FIG. 1 illustrates a repeater interface unit of the simplest structure on a TX path that performs conversion between three adjacent frequency assignments (FAs) and an optical transmission frequency. Referring to FIG. 1, the repeater interface unit includes a mixer 112 for mixing an input signal with a conversion reference wave; a reference wave generator 114 for generating the conversion reference wave having three frequencies; a PLL circuit 116 for stabilizing the reference wave generated by the reference wave generator 114; and a band pass filter 118 for filtering an output signal of the mixer 112.

The input signal is an analog output signal of a D/A converter (not shown). The input signal has a frequency band between 10.5 MHz and 19.5 MHz including a central frequency of 15 MHz. In this comparative example, the input signal has a fixed frequency depending on a specification of equipment comprising the repeater interface unit.

The reference wave may have a frequency of 110 MHz, 101 MHz or 119 MHhz according to a setting signal for designating the FA. When the input signal having the frequency bandwidth is mixed with the reference wave of 110 MHz, an output signal having a frequency band between 120.5 MHz and 129.5 MHz including a central frequency of 125 MHz is generated. Since this signal having a frequency band between 120.5 MHz and 129.5 MHz is used for frequency conversion, other frequencies are regarded as noise and suppressed as much as possible. To this end, the band pass filter may have a pass bandwidth from 120.5 MHz to 129.5 MHz. The mixer also generates a signal having a frequency band between 91.5 MHz and 99.5 MHz including a central frequency of 95 MHz. Preferably, this signal is eliminated by the band pass filter since it is not used for frequency conversion.

Meanwhile, when the input signal having a frequency band between 10.5 MHz and 19.5 MHz is mixed with the reference wave of 101 MHz according to the setting signal, an output signal having a frequency band between 111.5 MHz and 120.5 MHz is generated. In this case, the band pass filter may have a pass bandwidth from 111.5 MHz to 120.5 MHz to eliminate noise as much as possible. Finally, when the input signal having a frequency band between 10.5 MHz and 19.5 MHz is mixed with the reference wave of 119 MHz according to the setting signal, an output signal having a frequency band between 129.5 MHz and 138.5 MHz is generated. In this case, the band pass filter may have a pass bandwidth from 129.5 MHz to 138.5 MHz to eliminate noise as much as possible.

The PLL circuit 116 serves to fix the frequency of the reference wave generated by the reference wave generator so that the reference wave is stabilized against external shock. The PLL circuit 116 may be implemented by a PLL circuit which is widely used in data communication. The repeater interface unit may comprise three PLL circuits each corresponding to one of the three frequencies of the reference wave. Preferably, for reduction of cost and space, the repeater interface unit may comprise a variable PLL circuit capable of outputting a reference wave with a frequency that varies by 9 MHz.

The repeater interface unit may comprise three band pass filters, one of which is selected according to the setting signal for determining the frequency of the reference wave. Alternatively, the repeater interface unit may comprise one band pass filter with a fixed bandwidth of about 30 MHz irrespective of the frequency of the reference wave. However, the former has the disadvantages of being costly and large, and the latter has the disadvantage of insufficient noise filtering due to its overly broad bandwidth.

### Comparative Example 2

FIG. 2 illustrates a repeater interface unit of the simplest structure on an RX path that performs conversion between three adjacent frequency assignments (FAs) and an optical transmission frequency. Referring to FIG. 2, the repeater interface unit includes a mixer 212 for mixing an input signal with a conversion reference wave; a reference wave generator 214 for generating the conversion reference wave having one of three frequencies; a PLL circuit 216 for stabilizing the reference wave generated by the reference wave generator 214; and a band pass filter 218 for filtering an output signal of the mixer 212.

The input signal has a frequency band between 70.5 MHz and 79.5 MHz including a central frequency of 75 MHz, a frequency band between 61.5 MHz and 70.5 MHz including a central frequency of 66 MHz, or a frequency band between 79.5 MHz and 88.5 MHz including a central frequency of 84 MHz.

The reference wave generator 214 generates the reference wave having a frequency of 51 MHz, 60 MHz, or 69 MHz selected according to an external control signal. The reference wave generator 214 generates the reference wave of 51 MHz when the central frequency of the input signal is 66 MHz, the reference wave of 60 MHz when the central frequency of the input signal is 75 MHz, and the reference wave of 69 MHz when the central frequency of the input signal is 84 MHz. Accordingly, the mixer always outputs a signal with a frequency band between 10 MHz to 19.5 MHz including a central frequency of 15 MHz. The fixed bandwidth of output signal depends on specifications of equipment comprising the repeater interface unit according to the present comparative example. To suppress a signal and/or noise mixed in a plus direction, the band pass filter 218 has a pass bandwidth of about 10 MHz.

The PLL circuit 216 serves to fix the frequency of the reference wave generated by the reference wave generator 214 so that the reference wave is stabilized against external shock. The PLL circuit 116 may be implemented by a PLL circuit which is widely used in the field of data communication.

However, the repeater interface unit may comprise three PLL circuits each corresponding to one of the three frequencies of the reference wave. Preferably, for reduction of cost and space, the repeater interface unit may comprise a variable PLL circuit capable of outputting a reference wave having a frequency that varies by 9 MHz. However, the 9 MHz variable PLL circuit is technically difficult to implement at a frequency of 90 MHz or less.

Exemplary embodiments will now be described in terms of a repeater for mixing an input signal in a plus direction and then in a minus direction to solve problems associated with the comparative examples.

### First Exemplary Embodiment

The first and second comparative examples have difficulties in implementing the PLL circuit and the band pass filter. The present exemplary embodiment and a second exemplary embodiment which will be described later address the problems by converting an input signal into a signal having a predetermined intermediate band that is higher than the input signal and an output signal.

In the present exemplary embodiment, the repeater interface unit may be applied to a TX path in a base station of a wireless communication system. For example, a repeater interface unit for an optical repeater may be adapted to convert a signal input from a D/A converter in a base station into a signal with a suitable frequency, and output the signal to an optical repeater module at a remote location from the base station.

Specifically, in an optical repeater of a mobile Internet system, the repeater interface unit for a TX path needs to convert an input signal having a frequency band between 10.5 MHz and 19.5 MHz including a central frequency of 15 MHz into an output signal including a central frequency of 125 MHz. For the case where there are a number of FAs or the case where a number of signals within sector are processed by one repeater interface unit, a central frequency of an output signal of the repeater interface unit for the TX path according to the present embodiment is at least one of 125 MHz and a frequency obtained by increasing or decreasing 125 MHz by 9 MHz in order to support both 1FA/3sector and 3FA/OMNI. The present invention is not limited to the present exemplary embodiment but may be modified without departing from the spirit and scope of the present invention.

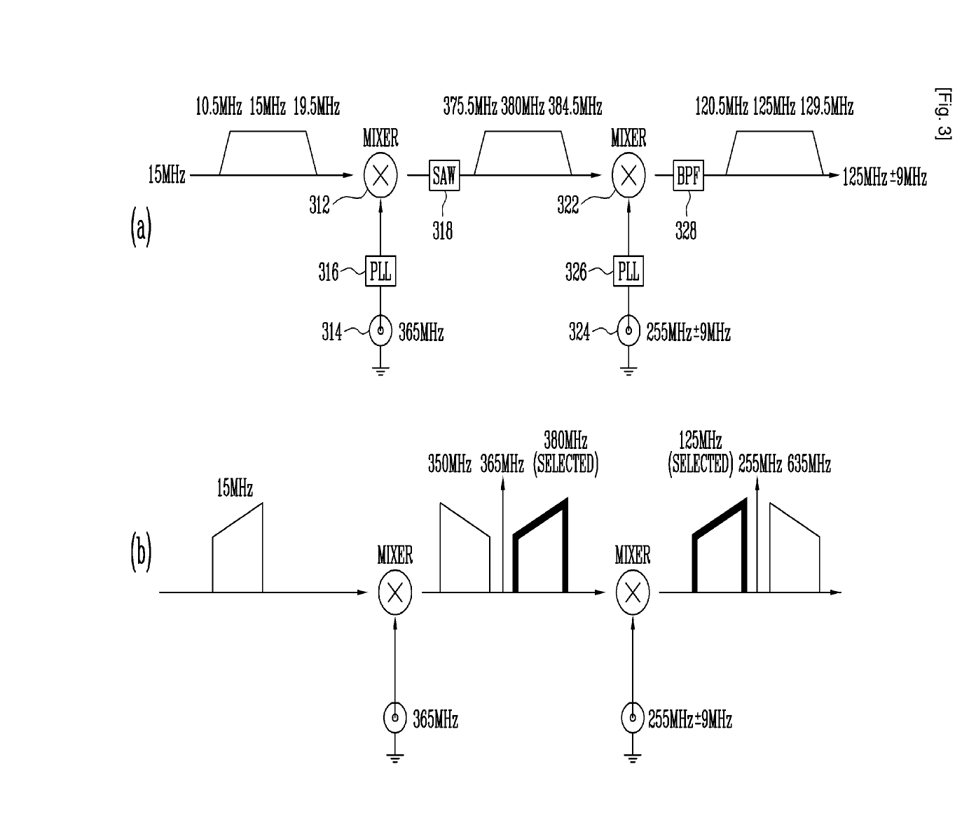

FIG. 3a shows an example of a repeater interface unit for a TX path which generates an output signal having one of 125, 134, and 116 MHz for a 1FA/3sector- or 3FA-based implementation. The input/output signals and the intermediate band signal of the repeater interface unit may have frequencies different from those shown in FIG. 3a. The output signal may have two frequencies or four or more frequencies.

Referring to FIG. 3a, the repeater interface unit includes a first reference signal generator 314 for generating a first reference signal; a first mixer 312 for mixing the input signal with the first reference signal and for generating an intermediate band signal having a higher central frequency than the input signal; a second reference signal generator 324 for generating a second reference signal having one of three frequencies; a second mixer 322 for mixing the intermediate band signal generated by the first mixer with the second reference signal and for generating an output signal having a lower central frequency than the intermediate band signal; a first band pass filter 318 for filtering the output signal of the first mixer 312; and a second band pass filter 328 for filtering the output signal of the second mixer to select a minus mixing signal therefrom. The repeater interface unit further includes a first PLL circuit 316 for stabilizing the first reference signal, and a second PLL circuit 326 for stabilizing the second reference signal.

For example, the input signal has a frequency band between 10.5 MHz and 19.5 MHz including a central frequency of 15 MHz input from a D/A converter. In the present exemplary embodiment, the input signal has a fixed frequency that depends on specifications of equipment comprising the repeater interface unit.

In general, among the two signals to be mixed, one is a data signal having a bandwidth of a predetermined size, and the other is a signal with a single frequency and functions as the reference signal. When the two signals are mixed, a plus mixing signal having a frequency increased by the frequency of the reference signal, and a minus mixing signal having a frequency decreased by the frequency of the reference signal are generated. Here, when the frequency of the reference signal is higher, the plus mixing signal has the same phase pattern as the original data signal and the minus mixing signal has an opposite phase pattern to the original data signal. When the frequency of the reference signal is lower, the plus mixing signal has an opposite phase pattern to the original data signal and the minus mixing signal has the same phase pattern as the original data signal.

In the present exemplary embodiment, each of the first mixer 312 and the second mixer 322 mixes the two signals to generate an output signal having a frequency corresponding to the frequency of one of the two signals plus the frequency of the other, i.e., a plus mixing signal, and to generate an output signal having the frequency of one of the two signals minus the frequency of the other, i.e., a minus mixing signal.

To convert the input signal into an intermediate band signal of 380 MHz, the first mixer 312 uses the first reference signal with a fixed frequency of 365 MHz. Accordingly, the first reference signal generator 314 may include an oscillating circuit for generating the 365 MHz reference signal. The first PLL circuit 316 may be implemented by a circuit synchronized to 365 MHz. Since there is little chance of frequency variation as the first reference signal generator 314 generates the fixed frequency, the interface unit may need not the first PLL circuit 316. The intermediate band signal from the first mixer 312 has a frequency band between 375.5 MHz and 384.5 MHz including a central frequency of 380 MHz. Since 380 MHz is a widely used frequency in wireless signal processing, a device for processing an intermediate band signal having a frequency band around 380 MHz can be easily configured.

The second reference signal generator 324 generates a second reference signal with a frequency of 246 MHz, 255 MHz, or 264 MHz according to a setting signal. The setting signal may be a control signal received from an external device (e.g., an optical repeater) when the repeater interface unit operates. The setting signal may be a value fixed and stored using hardware, e.g., a DIP switch, or using software. The second PLL circuit 326 is a 9 MHz-variable PLL circuit for stabilizing the second reference signal having a frequency of 246 MHz, 255 MHz, or 264 MHz. Here, it can be seen that a variable PLL circuit may be easily implemented because the variable PLL frequency is as high as 250 MHz.

The second mixer 322 outputs an output signal having a frequency band between 111.5 MHz and 120.5 MHz at the 246 MHz reference signal, between 120.5 MHz and 129.5 MHz at the 255 MHz reference signal, and between 129.5 MHz and 138.5 MHz at the 264 MHz reference signal, according to the setting signal.

To filter the output signal of the second mixer 322, the second band pass filter 328 may have one of three pass bands between 111.5 MHz and 120.5 MHz, 120.5 MHz and 129.5 MHz, and 129.5 MHz and 138.5 MHz according to the setting signal for determining the frequency of the reference signal, or may have a fixed pass bandwidth of about 30 MHz, i.e., a pass band between 111.5 MHz and 138.5 MHz irrespective of the frequency of the reference signal. The former has the disadvantages of being costly and large. Accordingly, the latter is preferred. To address an issue of insufficient noise blocking performance due to the broad filter bandwidth in the latter, the interface unit comprises the first band pass filter 318 having an intermediate pass band, i.e., a 10 MHz pass bandwidth between 375.5 MHz and 384.5 MHz. In the former, the interface unit may need not the first band pass filter 318. The first band pass filter may be implemented by a surface acoustic wave (SAW) filter. The output signal of the second band pass filter is provided to an external optical repeater module.

The process of converting the input signal and generating the output signal will be described in greater detail. This signal conversion process may be applied, particularly, to a wireless communication system that establishes a transmission path to a repeater by converting an IF input signal having a frequency that is lower than that of an RF signal into an IF output signal having a different central frequency from the IF input signal and outputting it.

The method for signal conversion in a repeater interface unit according to the present exemplary embodiment includes a step of mixing the input signal with the first reference signal to generate an intermediate band signal having a higher central frequency than the input signal; a step of filtering the intermediate band signal to select the plus mixing signal therefrom (a first filtering step); a step of mixing the selected plus mixing signal with the second reference signal to generate an output signal having a central frequency that is between those of the input signal and the intermediate band signal; and a step of filtering the output signal to select a minus mixing signal therefrom (a second filtering step).

In the intermediate band signal generating step, the intermediate band signal includes a plus mixing signal having a central frequency corresponding to the central frequency of the first reference signal plus the central frequency of the input signal, and a minus mixing signal having a central frequency corresponding to the central frequency of the first reference signal minus the central frequency of the input signal.

In the first filtering step, the filtering is performed by a band pass filter. The band pass filter passes only the plus mixing signal having a higher central frequency than that of the input signal, which is obtained by mixing the input signal with the first reference signal.

In the output signal generating step, the output signal obtained by mixing the intermediate band signal with the second reference signal includes a plus mixing signal having a central frequency corresponding to the central frequency of the intermediate band signal plus the central frequency of the second reference signal, and a minus mixing signal having a central frequency corresponding to the central frequency of the intermediate band signal minus the central frequency of the second reference signal.

In the second filtering step, the filtering is performed by a band pass filter. The band pass filter passes only the minus mixing signal having a lower central frequency than the input signal, which is obtained by mixing the intermediate band signal with the second reference signal. Here, the band pass filter may have a bandwidth that can pass all minus mixing signals generated by the respective reference signals since the second reference signal has a selected one of a number of frequencies (in FIG. 3a, three frequencies of 246 MHz, 255 MHz and 264 MHz).

FIG. 3b illustrates selecting the output signals of the first mixer 312 and the second mixer 322. As shown in FIG. 3b, the output signal of the first mixer 312 includes a plus mixing signal having a frequency corresponding to the frequency of the input signal plus the frequency of the first reference signal and having the same pattern as the input signal, and a minus mixing signal having a frequency corresponding to the first reference signal frequency minus the input signal frequency and having the same pattern as the input signal with respect to 365 MHz. The first band pass filter 418 selects only the plus mixing signal. The second band pass filter 428 selects only the minus mixing signal from the output signal of the second mixer 322. In FIG. 3a, the interface unit comprises the two band pass filters 318 and 328 to select the bandwidth of the output signal. For structural simplification, the interface unit may comprise only the second band pass filter.

### Second Exemplary Embodiment

In the second exemplary embodiment, the repeater interface unit may be applied to an RX path in a base station of a wireless communication system. For example, a repeater interface unit for an optical repeater may be adapted to convert a signal input from an optical repeater module at a remote location from a base station system into a signal with a suitable frequency and output the signal to an A/D converter of the base station. Specifically, in a base station of a mobile Internet system, the repeater interface unit for an RX path needs to convert an input signal having a frequency band between 120.5 MHz and 129.5 MHz including a central frequency of 125 MHz into an output signal including a central frequency of 15 MHz. For the case where there are a number of FAs or the case where a number of signals within sector are processed by one repeater interface unit, the repeater interface unit for the RX path according to the present embodiment is preferably adapted to receive and process an input signal having at least one of 125 MHz, 125 MHz+9 MHz, and 125 MHz−9 MHz as a central frequency.

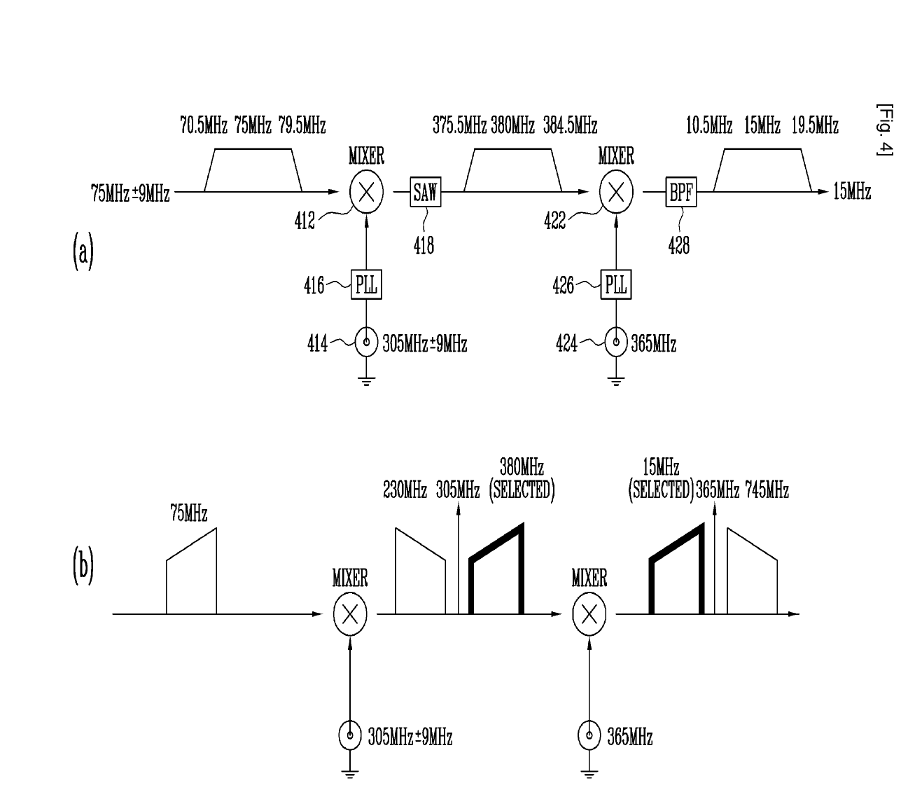

FIG. 4a shows a repeater interface unit for an RX path for processing an input signal having a selected one of 125 MHz, 134 MHz, and 116 MHz for a 1FA/3sector- or 3FA-based implementation. The input/output signals and the intermediate band signal of the repeater interface unit may have frequencies different from those shown in FIG. 4a. The input signal may have two frequencies or four or more frequencies.

Referring to FIG. 4a, the repeater interface unit includes a first reference signal generator 414 for generating a first reference signal having a selected one of three frequencies for intermediate band signal conversion; a first mixer 412 for mixing the input signal with the first reference signal and for generating an intermediate band signal having a higher central frequency than the input signal; a second reference signal generator 424 for generating a second reference signal; a second mixer 422 for mixing the intermediate band signal generated by the first mixer with the second reference signal and for generating an output signal having a lower central frequency than the intermediate band signal; a first band pass filter 418 for filtering the output signal of the first mixer 412; and a second band pass filter 428 for passing a minus mixing signal of the output signal of the second mixer. The repeater interface unit further includes a first PLL circuit 416 for stabilizing the first reference signal, and a second PLL circuit 426 for stabilizing the second reference signal.

For example, the input signal is from an external optical repeater module (not shown), which has a frequency band between 70.5 MHz and 79.5 MHz including a central frequency of 75 MHz, between 61.5 MHz and 70.5 MHz including a central frequency of 66 MHz, or between 79.5 MHz and 88.5 MHz including a central frequency of 84 MHz.

The first reference signal generator 414 generates a reference signal with a frequency of 296 MHz, 305 MHz, or 314 MHz according to an external control signal. The first reference signal generator 414 generates the 314 MHz reference signal when the central frequency of the input signal is 66 MHz, the 305 MHz reference signal when it is 75 MHz, and the 296 MHz reference signal when it is 84 MHz. That is, the first reference signal generator 414 generates the first reference signal of 314 MHz at the input signal of 61.5 MHz to 70.5 MHz, 305 MHz at the input signal of 70.5 MHz to 79.5 MHz, and 296 MHz at the input signal of 79.5 MHz to 88.5 MHz. Accordingly, the output from the first mixer 412 has a frequency band between 375.5 MHz and 384.5 MHz including a central frequency of 380 MHz. Here, since 380 MHz is a widely used frequency in wireless signal processing, a device for processing an intermediate band signal having a frequency band around 380 MHz can be configured without difficulty.

The reference signal frequency of the first reference signal generator 414 may be determined in real time based on the frequency of the input signal detected using a separate unit for detecting the frequency of the input signal or from tag information for the input signal, or may be fixed in advance using hardware, e.g., using a DIP switch, using software.

To convert the intermediate band signal into the output signal, the second mixer 422 uses the reference signal with a fixed frequency of 365 MHz. Accordingly, the second reference signal generator 424 may include an oscillating circuit for generating the 365 MHz reference signal. The second PLL circuit 426 may be implemented by a circuit synchronized to 365 MHz. Since the chances of frequency change are low as the second reference signal generator 424 generates the fixed frequency, the interface unit may need not the second PLL circuit 426. The output signal from the second mixer 422 has a frequency band between 10.5 MHz and 19.5 MHz including a central frequency of 15 MHz. This implies that only the minus mixing signal is selected from the output of the second mixer. To suppress the plus mixing signal and/or noise, the second band pass filter 428 is used which has a pass bandwidth of about 10 MHz and a central frequency of 15 MHz. The fixed bandwidth of the output signal depends on specifications of equipment comprising the repeater interface unit of the present exemplary embodiment.

The interface unit may comprise the first band pass filter 418 for filtering the output signal of the first mixer 412. The first band pass filter 418 may be implemented by one filter having a bandwidth of about 10 MHz and a variable central frequency or three filters having a bandwidth of 10 MHz and different central frequencies. Preferably, the first band pass filter 418 is implemented by a filter having a bandwidth of about 30 MHz and a fixed central frequency of 380 MHz. The first band pass filter may be implemented by a surface acoustic wave (SAW) filter. The output signal of the second band pass filter 428 is provided to an external AD converter.

The process of converting the input signal and generating the output signal will be described in greater detail. This signal conversion process may be applied, particularly, to a wireless communication system that establishes a transmission path to a repeater by converting an IF input signal having a frequency that is lower than that of an RF signal into an IF output signal having a different central frequency from the IF input signal and outputting it.

The method for signal conversion in a repeater interface unit according to the present exemplary embodiment includes a step of mixing the input signal with the first reference signal to generate an intermediate band signal having a higher central frequency than the input signal; a step of filtering the intermediate band signal to select the plus mixing signal therefrom (a first filtering step); a step of mixing the selected plus mixing signal with the second reference signal to generate an output signal having a central frequency that is between those of a baseband signal and the input signal; and a step of filtering the output signal to select a minus mixing signal therefrom (a second filtering step).

In the intermediate band signal generating step, the intermediate band signal includes a plus mixing signal having a central frequency corresponding to the central frequency of the first reference wave plus the central frequency of the input signal, and a minus mixing signal having a central frequency corresponding to the central frequency of the first reference wave minus the central frequency of the input signal.

In the first filtering step, the filtering is performed by a band pass filter. The band pass filter passes only the plus mixing signal having a higher central frequency than that of the input signal, which is obtained by mixing the input signal with the first reference signal. Here, since the first reference signal has a selected one of a number of frequencies (in FIG. 4a, three frequencies of 296 MHz, 305 MHz and 314 MHz) according to the frequency of the input signal, the band pass filter may have a bandwidth between 375 MHz and 384 MHz.

In the output signal generating step, the output signal obtained by mixing the intermediate band signal with the second reference signal includes a plus mixing signal having a central frequency corresponding to the central frequency of the intermediate band signal plus the central frequency of the second reference signal, and a minus mixing signal having a central frequency corresponding to the central frequency of the intermediate band signal minus the central frequency of the second reference signal.

In the second filtering step, the filtering is performed by a band pass filter. The band pass filter passes only the minus mixing signal having a lower central frequency than the input signal, which is obtained by mixing the intermediate band signal with the second reference signal.

FIG. 4b illustrates selecting the output signals of the first mixer 412 and the second mixer 422. As shown in FIG. 4b, only the plus mixing signal of the output signal of the first mixer 412 is selected and only the minus mixing signal of the output signal of the second mixer 422 is selected. The selection of the plus mixing signal and the minus mixing signal may be performed by the first band pass filter 418 and/or the second band pass filter 428.

While the invention has been shown and described with reference to certain exemplary embodiments thereof, it will be understood by those skilled in the art that various changes in form and details may be made therein without departing from the spirit and scope of the invention as defined by the appended claims.

1. A repeater interface unit in a wireless communication system converts an intermediate frequency (IF) input signal having a lower frequency than a radio frequency (RF) signal into an IF output signal having a different central frequency from the IF input signal and outputting the IF output signal, the repeater interface unit comprising:
a first reference signal generator for generating a first reference signal;
a first mixer for mixing the input signal with the first reference signal and for generating an intermediate band signal having a higher central frequency than the input signal;
a second reference signal generator for generating a second reference signal;
a second mixer for mixing the intermediate band signal generated by the first mixer with the second reference signal and for generating an output signal having a lower central frequency than the intermediate band signal; and
a second filtering means for filtering the output signal of the second mixer to select a minus mixing signal.

2. The repeater interface unit according to claim 1, further comprising a first phase locked loop (PLL) circuit for stabilizing a waveform of the first reference signal generated by the first reference signal generator.

3. The repeater interface unit according to claim 1, further comprising a second PLL circuit for stabilizing a waveform of the second reference signal generated by the second reference signal generator.

4. The repeater interface unit according to claim 1, wherein the intermediate band signal has a central frequency that is higher than frequencies of the input signal and the output signal.

5. The repeater interface unit according to claim 1, wherein the intermediate band signal has a central frequency of 380 MHz.

6. The repeater interface unit according to claim 1, wherein the intermediate band signal is an analog signal having a frequency band between 375.5 MHz and 384.5 MHz including a central frequency of 380 MHz.

7. The repeater interface unit according to claim 1, wherein the first mixer mixes the input signal with the first reference signal and generates the intermediate band signal including a plus mixing signal having a central frequency corresponding to the first reference signal plus the input signal, and a minus mixing signal having a central frequency corresponding to the first reference signal minus the input signal.

8. The repeater interface unit according to claim 1, further comprising a first filtering means for selecting a plus mixing signal from the intermediate band signal.

9. The repeater interface unit according to claim 1, wherein the second mixer mixes the intermediate band signal with the second reference signal and for generating the output signal including a plus mixing signal having a central frequency corresponding to a central frequency of the intermediate band signal plus a central frequency of the second reference signal, and a minus mixing signal having a central frequency corresponding to the intermediate band signal minus the second reference signal.

10. The repeater interface unit according to claim 1, wherein the second reference signal generator generates a second reference signal having a selected one of a plurality of frequencies according to a setting signal.

11. The repeater interface unit according to claim 1, wherein the repeater interface unit generates an output signal having a higher central frequency than the input signal in order to establish a transmission (Tx) path with a repeater module.

12. The repeater interface unit according to claim 1, wherein the input signal has a central frequency of 15 MHz, and the output signal has at least one of central frequencies of 116 MHz, 125 MHz and 134 MHz.

13. The repeater interface unit according to claim 1, wherein the first reference signal generator generates a first reference signal having a central frequency of 365 MHz, and the second reference signal generator generates a second reference signal having at least one of central frequencies of 246 MHz, 255 MHz and 264 MHz.

14. The repeater interface unit according to claim 1, wherein the second filtering means is a band pass filter for passing a minus mixing signal obtained by mixing the intermediate band signal with the second reference signal.

15. The repeater interface unit according to claim 1, wherein the first reference signal generator generates the first reference signal having a selected one of a plurality of frequencies according to a bandwidth of the input signal.

16. The repeater interface unit according to claim 1, wherein the repeater interface unit generates an output signal having a lower central frequency than the input signal in order to establish a reception (Rx) path with a repeater module.

17. The repeater interface unit according to claim 1, wherein the input signal has a central frequency of 75 MHz, and the output signal has at least one of central frequencies of 6 MHz, 15 MHz and 24 MHz.

18. The repeater interface unit according to claim 1, wherein the first reference signal has at least one of central frequencies of 296 MHz, 305 MHz and 314 MHz, and the second reference signal has a central frequency of 365 MHz.

19. The repeater interface unit according to claim 8, wherein the first filtering means passes a plus mixing signal, which is obtained by mixing the input signal with the first reference signal.

20. A method for signal conversion in a repeater interface unit of a wireless communication system converts an IF input signal having a lower frequency than an RF signal into an IF output signal having a different central frequency from the IF input signal and outputting the IF output signal, the method comprising the steps of:
(a-1) mixing the input signal with a first reference signal and obtaining an intermediate band signal having a higher central frequency than the input signal;
(a-2) filtering the intermediate band signal to select a plus mixing signal;
(a-3) mixing the plus mixing signal with a second reference signal and obtaining an output signal having a central frequency that is between those of the input signal and the intermediate band signal; and
(a-4) filtering the output signal to select a minus mixing signal.

21. The method according to claim 20, wherein step (a-1) comprises generating the intermediate band signal including a plus mixing signal having a central frequency corresponding to the first reference signal plus the input signal, and a minus mixing signal having a central frequency corresponding to the first reference signal minus the input signal.

22. The method according to claim 20, wherein step (a-3) comprises mixing the intermediate band signal with the second reference signal and generating the output signal including a plus mixing signal having a central frequency corresponding to the intermediate band signal plus the second reference signal, and a minus mixing signal having a central frequency corresponding to the intermediate band signal minus the second reference signal.

23. The method according to claim 20, wherein step (a-3) comprises mixing the plus mixing signal with a selected one of a plurality of second reference signals having central frequencies at certain intervals to obtain the output signal.

24. A method for signal conversion in a repeater interface unit of a wireless communication system converts an IF input signal having a lower frequency than an RF signal into an IF output signal having a different central frequency from the IF input signal and outputting the IF output signal, the method comprising the steps of:
(b-1) mixing the input signal with a first reference signal and obtaining an intermediate band signal having a higher central frequency than the input signal;
(b-2) filtering the intermediate band signal to select a plus mixing signal;
(b-3) mixing the plus mixing signal with a second reference signal and obtaining an output signal having a central frequency that is between those of a baseband signal and the input signal; and
(b-4) filtering the output signal to select a minus mixing signal.

25. The method according to claim 24, wherein step (b-1) comprises generating the intermediate band signal including a plus mixing signal having a central frequency corresponding to the first reference signal plus the input signal, and a minus mixing signal having a central frequency corresponding to the first reference signal minus the input signal.

26. The method according to claim 24, wherein step (b-3) comprises mixing the intermediate band signal with the second reference signal and generating the output signal including a plus mixing signal having a central frequency corresponding to the intermediate band signal plus the second reference signal, and a minus mixing signal having a central frequency corresponding to the intermediate band signal minus the second reference signal.

27. The method according to claim 24, wherein step (b-1) comprises mixing the plus mixing signal with a selected one of a plurality of first reference signals having central frequencies at certain intervals to generate the output signal.
